(19) United States
(12) Patent Application Publication
(10) Pub. No.: US 2025/0284924 A1
(43) Pub. Date: Sep. 11, 2025

(54) SUPERCONDUCTING THERMODYNAMIC NEURON

(71) Applicant: EXTROPIC COMPUTING CANADA CORP., Toronto (CA)

(72) Inventors: Jérémy Béjanin, Sherbrooke (CA); Guillaume Verdon-Akzam, San Francisco, CA (US)

(21) Appl. No.: 19/073,788

(22) Filed: Mar. 7, 2025

Related U.S. Application Data
(60) Provisional application No. 63/562,669, filed on Mar. 7, 2024.

(51) Int. Cl. G06N 3/02

(52) U.S. Cl. CPC G06N 3/02

(57) ABSTRACT

Various superconducting thermodynamic systems and methods of operating a thermodynamic network that includes superconducting thermodynamic neurons and tunable couplers are described herein. Each superconducting neuron of at least a subset of the superconducting thermodynamic neurons is coupled to at least one other superconducting thermodynamic neuron via a corresponding tunable coupler. The method involves initializing the thermodynamic network by defining an initial state of at least a subset of the superconducting thermodynamic neurons corresponding to input neurons in the thermodynamic network, allowing the thermodynamic network to time-evolve over a predetermined time period and measuring a plurality of output states of a corresponding plurality of output neurons of the superconducting thermodynamic neurons after expiry of the time period. Each superconducting thermodynamic neuron includes one or more Josephson junctions, an inductive element, a capacitive element and a resistive element connected in parallel.

### CROSS-REFERENCE TO RELATED APPLICATION

This application claims priority from U.S. Provisional Patent Application Ser. No. 63/562,669, filed Mar. 7, 2024, the entire contents of which is hereby incorporated by reference.

### FIELD OF THE INVENTION

The described embodiments relate generally to neuromorphic computing and in particular, to a superconducting thermodynamic neuron circuit and methods of operating a thermodynamic network of superconducting thermodynamic neurons.

### BACKGROUND

Artificial intelligence, machine learning and deep learning solutions have become increasingly prevalent for solving computing problems. These solutions adopt approaches that rely on processing data in a way that is inspired by the human brain. Computing problems solved by these solutions are, however, often complex, requiring extensive training of models and computational resources. Large training models can be particularly computationally expensive and require significant processing resources in addition to having high data storage requirements. In addition, after training, running these models is also computationally expensive, since a model is trained once, but ran many times and may require many computations to be performed.

There is a need for improved computing systems.

### SUMMARY

The following summary is intended to introduce the reader to various aspects of the detailed description, but not to define or delimit any invention.

In accordance with an aspect of this disclosure, there is provided a method of operating a thermodynamic network comprising a plurality of superconducting neurons and a plurality of tunable couplers, wherein each superconducting neuron of at least a subset of the plurality of superconducting thermodynamic neurons is coupled to at least one other superconducting thermodynamic neuron via a corresponding tunable coupler. The method involves: initializing the thermodynamic network by defining an initial state of at least a subset of the plurality of superconducting thermodynamic neurons corresponding to input neurons in the thermodynamic network; allowing the thermodynamic network to time-evolve over a predetermined time period; and measuring a plurality of output states of a corresponding plurality of output neurons of the plurality of superconducting thermodynamic neurons after expiry of the time period.

In some embodiments, the initial state of the at least subset of the plurality of superconducting thermodynamic neuron is defined based on an encoding of input data being input into the thermodynamic network

In some embodiments, initializing the thermodynamic network comprises setting coupling strengths of the tunable couplers to predetermined coupling settings.

In some embodiments, the predetermined coupling settings are determined by operating the thermodynamic network through an iterative learning process, wherein the learning process is defined to optimize an energy function of the thermodynamic network.

In some embodiments, the energy function of the thermodynamic network is defined based on a model of dynamics of the thermodynamic network.

In some embodiments, initializing the thermodynamic network comprises defining neuron settings of at least a subset of the input neurons, the neuron settings comprising one or more of: a barrier height and a tilt of the superconducting neuron.

In some embodiments, the method further involves dynamically adjusting one or more of: at least some of the coupling strengths of the tunable couplers and at least some of the neuron settings during the predetermined time period.

In some embodiments, the method further involves decoding the plurality of output states to obtain output data associated with the initial state of the thermodynamic network.

In some embodiments, the superconducting thermodynamic neurons comprises a second subset of superconducting neurons coupled pairwise through mutual inductance.

In some embodiments, each of the plurality of superconducting thermodynamic neurons comprises: one or more Josephson junctions, an inductive element, a capacitive element, and a resistive element, wherein the one or more Josephson junctions, the inductive element, the capacitive element and the resistive element are connected in parallel.

In accordance with another aspect of this disclosure, there is provided a superconducting thermodynamic system including: a thermodynamic network comprising: a plurality of superconducting thermodynamic neurons, a plurality of tunable couplers, wherein each superconducting neuron of at least a subset of the plurality of superconducting neurons is coupled to at least one other superconducting neuron via a tunable coupler of the plurality of tunable couplers; a readout circuit coupled to a plurality of output neurons of the plurality of superconducting neurons for measuring output states of the output neurons; and a controller for tuning coupling strengths of the tunable couplers.

In some embodiments, at least a subset of the plurality of superconducting thermodynamic neurons correspond to input neurons and wherein an initial state each input neuron is defined based on an encoding of input data being input into the thermodynamic network.

In some embodiments, the controller is configured to tune the coupling strengths to predetermined coupling settings.

In some embodiments, the predetermined coupling settings are determined by operating the thermodynamic network through an iterative learning process, wherein the learning process is defined to optimize an energy function of the thermodynamic network.

In some embodiments, the energy function of the thermodynamic network is defined based on a model of dynamics of the thermodynamic network.

In some embodiments, the controller is configured to define neuron settings of at least a subset of the input neurons, the neuron settings comprising one or more of: a barrier height and a tilt of the superconducting neuron.

In some embodiments, the controller is configured to dynamically adjust one or more of: at least some of the coupling strengths of the tunable couplers and at least some of the neuron settings when the thermodynamic network is time-evolved.

In some embodiments, the plurality of output states are decodable to obtain output data associated with an initial state of the thermodynamic network.

In some embodiments, the superconducting thermodynamic neurons comprises a second subset of superconducting neurons coupled pairwise through mutual inductance.

In some embodiments, each of the plurality of superconducting neurons comprises: one or more Josephson junctions; an inductive element; a capacitive element; and a resistive element, wherein the one or more Josephson junctions, the inductive element, the capacitive element and the resistive element are connected in parallel.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

Several embodiments will be described in detail with reference to the drawings, in which:

FIG. 1A shows a circuit diagram of an example superconducting thermodynamic neuron, in accordance with an embodiment;

FIG. 1B shows a circuit diagram of another example superconducting thermodynamic circuit, in accordance with an embodiment;

FIG. 2A shows a circuit diagram of two example superconducting thermodynamic neurons coupled directly together through mutual inductance, in accordance with an embodiment;

FIG. 2B shows a circuit diagram of two example superconducting thermodynamic neurons coupled together via a tunable coupler, in accordance with an embodiment;

FIG. 3 shows a circuit diagram of another example superconducting thermodynamic neuron coupled to control circuits, in accordance with an embodiment;

FIG. 4 shows a graph of the potential and components of the potential of an example superconducting thermodynamic neuron;

FIG. 5 shows a circuit diagram of the example superconducting thermodynamic neuron of FIG. 1, coupled to a readout circuit;

FIG. 6 shows a schematic diagram of an example implementation of a superconducting thermodynamic neuron coupled to a readout circuit and a control circuit;

FIG. 7 shows a graph of a position (phase) of an example superconducting thermodynamic neuron over time at two different temperatures; and

FIG. 8 shows a flowchart of a method of operating a thermodynamic network of superconducting neurons, in accordance with an embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

Unless otherwise indicated, the definitions and embodiments described in this and other sections are intended to be applicable to all embodiments and aspects of the present application herein described for which they are suitable as would be understood by a person skilled in the art.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

As used in this application, the singular forms “a”, “an” and “the” include plural references unless the content clearly dictates otherwise.

In embodiments comprising an “additional” or “second” component, the second component as used herein is physically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The present application provides non-linear superconducting thermodynamic neuromorphic computing neurons, circuits and methods for controlling the operation of a network of superconducting thermodynamic neurons and for measuring properties of the superconducting thermodynamic neurons. As will be described the superconducting thermodynamic neuron is termed “thermodynamic” because the operation of the superconducting neuron is in part driven by the energy of the thermodynamic environment (i.e., the thermal noise) (in addition to being operable by external control signals). The superconducting thermodynamic neurons described herein can be contrasted to quantum computing qubits, which are driven by individual pulses that affect the state of the qubits and aim to avoid all noise. The superconducting thermodynamic neurons described herein can also be operated at higher energy levels and higher temperatures when compared to quantum computing qubits, enabling the neurons to be operated as classical computing devices.

The superconducting thermodynamic neurons described herein can be operated at cryogenic temperatures (i.e., a temperature below the critical temperature of the material of the superconducting thermodynamic neurons). For example, the superconducting thermodynamic neurons can be placed in a cryogenic chamber. The external controls used for controlling neuron settings of the superconducting neurons may be operated at room temperature or at cryogenic temperatures.

The superconducting thermodynamic neurons described herein can be realized on a physical substrate and can include a combination of Josephson junctions, capacitive, inductive and resistive elements. The superconducting thermodynamic neurons described herein can be characterized by low energy losses.

The superconducting thermodynamic neurons described herein can be particularly well suited for machine-learning applications, for example, to generate samples for use in problems implemented with energy-based models. The noise-driven dynamics of the superconducting thermodynamic neurons can enable the neurons to reach thermal equilibrium rapidly, allowing problems modeled using energy-based models to be solved rapidly.

As will be described, the superconducting thermodynamic neurons can be coupled to form a network of superconducting thermodynamic neurons.

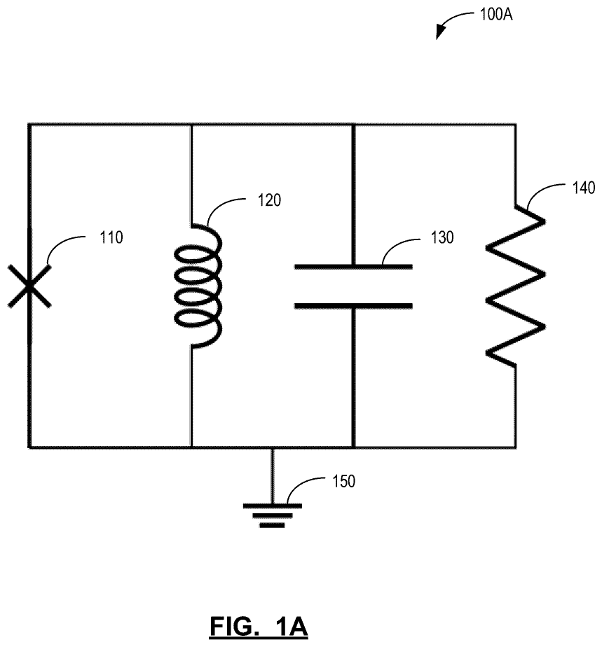

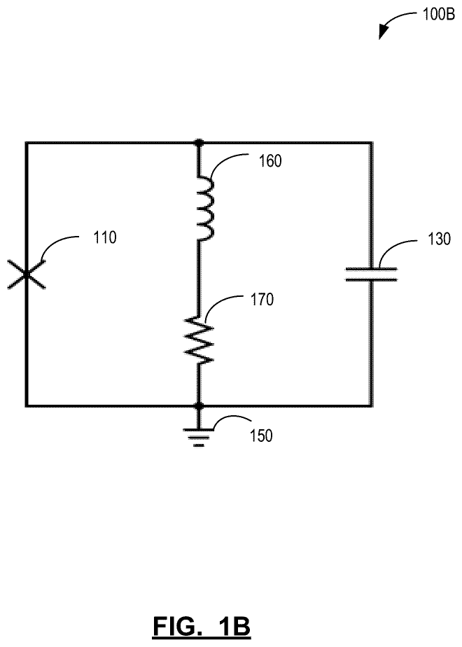

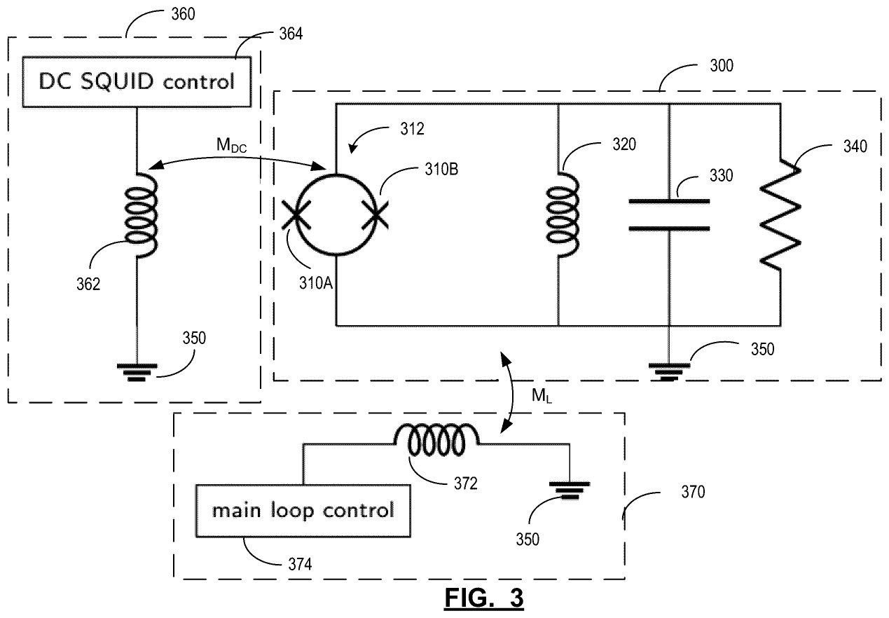

Referring first to FIG. 1A, there is shown a circuit diagram of an example superconducting thermodynamic neuron 100A. As shown, the superconducting thermodynamic neuron 100A includes a Josephson junction 110, an inductive element 120, a capacitive element 130 and a resistive element 140 connected in parallel and connected to ground 150. Although only one Josephson junction 110, one inductive element 120, one capacitive element 130 and one resistive element 140 are shown, the superconducting thermodynamic neuron can include one or more of each of these components and it will be understood that the superconducting thermodynamic neuron 100A can be defined by a circuit that is equivalent to the circuit shown in FIG. 1. For example, the superconducting thermodynamic neuron can include a second capacitive element connected in parallel with the capacitive element 130. As another example, the superconducting thermodynamic neuron can include a second Josephson junction connected in parallel with the Josephson junction 110 (see e.g. FIG. 3).

The Josephson junction 110 can be a lumped circuit element and the components 120, 130, 140 can be distributed elements, lumped elements or a combination of these. In embodiments where the capacitive element 130 and/or the inductive element 120 are distributed elements, the capacitance and the inductance, respectively, of the capacitive element 130 and the inductive element 120 can be distributed over the physical dimensions (e.g., length) of the components 130 and 120. In embodiments where the capacitive element 130 and/or the inductive element 120 are lumped elements, the capacitance and the inductance, respectively, of the capacitive element 130 and the inductive element 120 can be generally considered to be located at a point in the physical circuit. The superconducting thermodynamic neuron can be characterized by the critical current I_{C} of the Josephson junction 110, the inductance L of the inductive element 120, the capacitance C of the capacitive element 130 and the equivalent resistance R of the losses in the superconducting thermodynamic neuron.

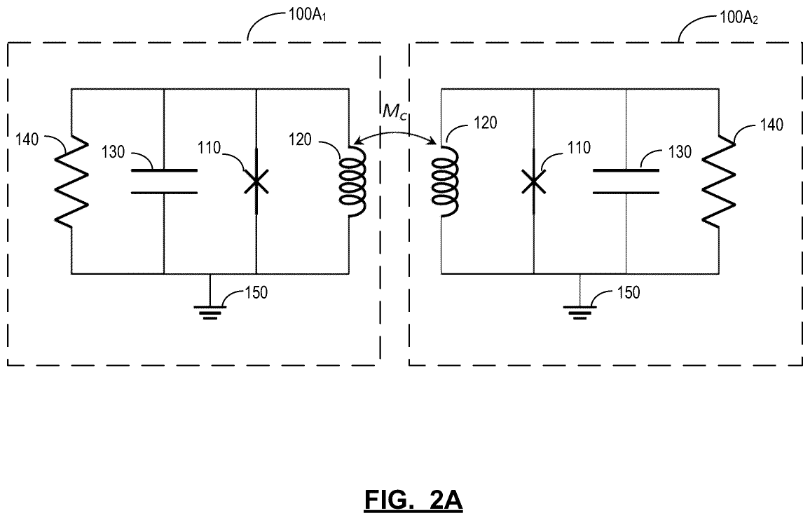

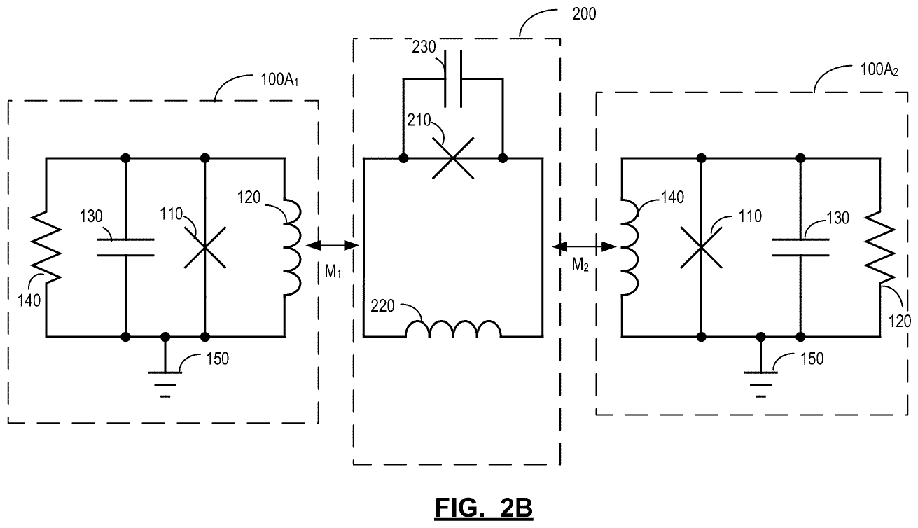

Referring briefly to FIG. 2A, which shows two coupled superconducting thermodynamic neurons 100A₁, 100A₂. As can be seen in FIG. 2A, a superconducting thermodynamic neuron can be coupled to one or more other superconducting thermodynamic neurons. For example, the superconducting thermodynamic neuron 100A₁, 100A₂ can be part of a network of superconducting thermodynamic neurons wherein each neuron is controlled individually, or two or more neurons are controlled by the same control line and/or control signals. In some embodiments, one or more neurons in a network of superconducting thermodynamic neurons can be operated without controls. As shown, the superconducting thermodynamic neurons can be inductively coupled pairwise via mutual inductance Mc between inductive elements 120 of each superconducting thermodynamic neuron.

Alternatively, as shown in FIG. 2B, the superconducting thermodynamic neurons 100A₁, 100A₂ can be coupled via a coupler circuit (e.g. a tunable coupler 200), which can couple two or more superconducting thermodynamic neurons. The coupler circuit can include one or more tunable coupling parameters that can be adjusted in order to define or adjust the coupling between the superconducting thermodynamic neurons 100A₁, 100A₂.

As shown in the example of FIG. 2B, the tunable coupler circuit 200 can be similar in structure to a superconducting thermodynamic neuron. For example, the tunable coupler 200 can include an inductive element 220, a Josephson junction 210 and a capacitive element 230, connected in parallel. The tunable coupler 200 can couple to each of superconducting thermodynamic neuron 100A₁, 100A₂ via mutual inductance M₁, M₂.

In some embodiments, one or more of the components 110, 120, 130 and 140 can be omitted. For example, in a network of superconducting thermodynamic neurons, the Josephson junction 110 can be omitted from one or more superconducting thermodynamic neurons.

Returning to FIG. 1A, the Josephson junction 110 can be formed of an insulator placed between two superconductors. The critical current I_{C} of the Josephson junction 210 can be about 0.04 μA to 20 μA resulting in a Josephson energy over the Planck constant h in the range of about 20 GHz to 10,000 GHz since the Josephson energy of the Josephson junction 110 is defined by E_{J}=ϕ₀I_{C}.

The inductive element 120 can be formed of an elongated piece of metal (e.g., wire, trace) that is capable of carrying current from the capacitive element 130 to ground 150. The inductive element 120 can have an inductance of about 50 pH to 1000 pH, resulting in an inductive energy divided by h in the range of about 3200 GHz to 160 GHZ, since the inductive energy of the inductive element 120 is defined by

$${E}_{L} = \frac{{ϕ}_{0}^{2}}{2 L} .$$

The capacitive element 130 can be formed of a piece of metal that can accumulate a charge with respect to ground 150. The capacitive element 130 can have a capacitance of about 5fF to 1000fF, resulting in a charging energy divided by h in the range of 4 GHz to 0.02 GHZ, since the charging energy of the capacitive element is defined by

$${E}_{C} = \frac{{e}^{2}}{2 C} .$$

The resistive element 140 can be formed of a piece of normal metal. Alternatively, the resistive element 140 can be intrinsic to the materials of the superconducting thermodynamic neuron (i.e., the resistive element 140 is not a separate element). The resistive element 140 can represent losses (intrinsic or extrinsic) in the superconducting thermodynamic neuron associated with the normal current flow and other electromagnetic losses. The resistive element 140 can have an equivalent resistance of about 1×10²Ω to 1×10⁷Ω.

Reference is briefly made to FIG. 1B, which shows a circuit diagram of another example superconducting thermodynamic neuron 100B. The superconducting thermodynamic neuron 100B of FIG. 1B can be substantially similar to the superconducting thermodynamic neuron 100A of FIG. 1A. However, as shown, the resistive element 160 can be in series with the inductive element 170.

The degree of freedom (i.e., the variable) of the superconducting thermodynamic neuron can be defined by the superconducting phase φ (i.e., state, position) across the Josephson junction 110. The superconducting phase φ can be defined by the flux ϕ across the Josephson junction 110, as defined in Equations 1-2 below:

$$ϕ = {ϕ}_{0} φ \qquad ( 1 )$$

$$ϕ ( t ) = {\int }_{- ∞}^{t} V ( {t}^{′} ) {dt}^{′} \qquad ( 2 )$$

where V is the voltage across the Josephson junction 110,

$${ϕ}_{0} = \frac{{Φ}_{0}}{2 π}$$

is the reduced flux quantum.

The behavior of the superconducting thermodynamic neuron can be varied at design time by selecting the parameters I_{C}, L, C and R of the components 110, 120, 130, 140.

Referring next to FIG. 3, there is shown a circuit diagram of another example superconducting thermodynamic neuron 300 coupled to control circuits 360 and 370. Though FIG. 3 shows control circuits 360 and 370 coupled to one superconducting thermodynamic neuron 300, as explained, in some embodiments, the control circuits 360, 370 can be coupled to more than one superconducting thermodynamic neuron 300 and provide control signals to more than one superconducting thermodynamic neuron. As shown, the superconducting thermodynamic neuron 300 of FIG. 3 can be substantially similar to the superconducting thermodynamic neuron 100A of FIG. 1A and include an inductive element 320, a capacitive element 330 and a resistive element 340 substantially similar to the elements 120, 130 and 140, respectively. However, the superconducting thermodynamic neuron 300 includes two Josephson junctions 310A, 310B connected in parallel, forming a loop 312 referred to as a DC superconducting quantum interference device (SQUID). The loop 312 formed by the Josephson junctions 310 can be small and have dimensions of about 40 μm×40 μm or smaller. The loop 312 can behave in a substantially similar manner to a single Josephson junction. However, the loop can have a critical current that is twice as large as the critical current of a single Josephson junction 310 (i.e., 2I_{C}).

The total critical current of the loop 312 can be tuned by applying an external magnetic flux through the loop 312. The external magnetic flux can be applied by a DC SQUID control circuit 360 inductively coupled to the loop 312 via mutual inductance MDC. The DC SQUID control circuit 360 can include an inductor 362 connected to ground 350 and connected to a DC SQUID control 364 which can transmit control signals (e.g., time-dependent control signals) that vary the current applied to the inductor 362 which in turn varies the external magnetic flux applied to the loop 312. One or more components of the DC SQUID control circuit 360 can be located on the same physical substrate as the circuit 300 or can be external to the physical substrate of the circuit 300.

The superconducting phase φ of the superconducting thermodynamic neuron 300 can be offset, or shifted, by applying an external magnetic flux to the larger loop formed by the loop 312 (DC SQUID) and the inductive element 320. The loop formed can be larger than the loop 312, and generally larger than 200 μm×200 μm. The external magnetic flux can be applied by a main inductance loop control circuit 370 via mutual inductance ML. The main inductance loop control circuit 370 can include an inductor 372 connected to ground 350 and a main loop control 374 which can transmit control signals (e.g., time-dependent control signals) that vary the current applied to the inductor 372 which in turn varies the external magnetic flux applied to the superconducting thermodynamic neuron 300. One or more components of the main inductance loop control circuit 370 can be located on the same physical substrate as the circuit of the superconducting thermodynamic neuron 300 or can be external to the physical substrate of the circuit of the superconducting thermodynamic neuron 300.

The potential of the circuit 300 can therefore be varied by varying the magnetic fluxes applied by the DC SQUID control circuit 360 and the main inductance loop control circuit 370. The potential of the circuit can be defined by the following equation:

$$U ( φ ) = \frac{{E}_{L}}{2} {( φ - {\tilde{φ}}_{L} )}^{2} + {E}_{J} ( {\tilde{φ}}_{D C} ) ( 1 - cos ( φ ) ) \qquad ( 3 )$$

where ϕ₀\tilde{φ}_{L} is the external magnetic flux applied by the main inductance loop control circuit 370, ϕ₀\hat{φ}_{DC} is the external magnetic flux applied to the loop 312, and

$${E}_{J} ( {\tilde{φ}}_{D C} ) = {E}_{J 0} cos ( \frac{{\tilde{φ}}_{D C}}{2} )$$

is the effective Josephson energy of the loop 312.

As explained, since \tilde{φ}_{DC} (t) and \tilde{φ}_{L} (t) can be varied overtime, the potential U(φ) can also vary overtime. The amplitude of the cosine part of the potential can be varied between ±E_{J0}, where E_{J0} can be 0, depending on external magnetic flux ϕ₀\tilde{φ}_{DC} applied to the loop 312. The potential can have a single-well shape or a tilted double-well shape, where the shape of the well is determined by the external magnetic flux ϕ₀\tilde{φ}_{DC} and the tilt of the double well is determined by the external magnetic flux \tilde{φ}_{L}.

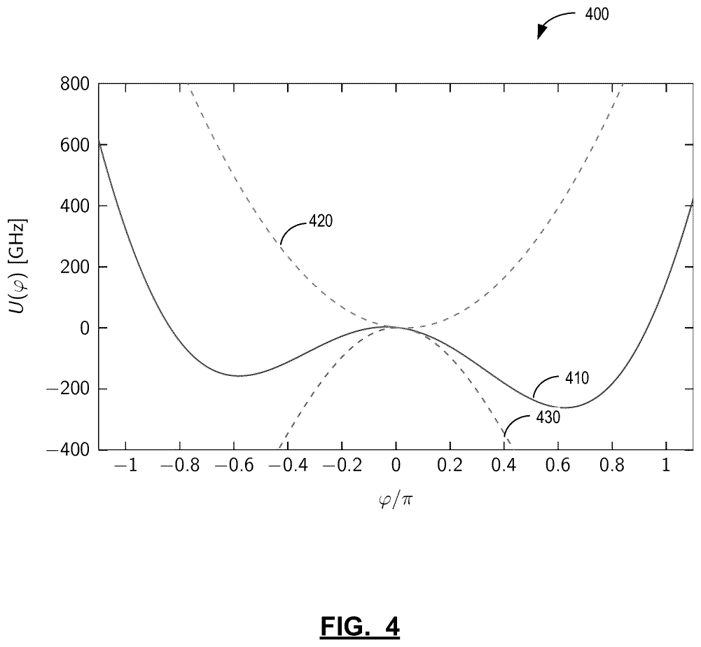

Referring to FIG. 4, there is shown a graph 400 of an example potential U(φ) 410 of the superconducting thermodynamic neuron 300 of FIG. 3, the harmonic part 420 of the potential and the cosine part 430 of the potential. As shown in graph 400, the potential U(φ) is well-shaped. The potential can have a single harmonic well shape (when E_{J0} is 0) or a double well shape, depending on the external magnetic flux ϕ₀\tilde{φ}_{DC}, which varies the height of the barrier between the two wells. Alternatively, the potential can have a single well with a quartic shape (not shown). The tilt of the potential can vary depending on the external magnetic flux ϕ₀\tilde{φ}_{L}.

As described, the superconducting thermodynamic neuron can be noise driven. That is, during operation of the superconducting thermodynamic neuron, noise can cause the position of the superconducting thermodynamic neuron to vary. The position of the superconducting thermodynamic neuron can then be measured to determine a solution (or predicted solution) to a given problem. The dynamics of the superconducting thermodynamic neuron can be defined by the following Langevin equation:

$$M \ddot{φ} + γ M \dot{φ} + ∇ U ( φ ) + \sqrt{2 γ {k}_{B} T M} W ( t ) = 0 where M = {ϕ}_{0}^{2} C , γ = \frac{η}{M} = \frac{1}{R C} , \qquad ( 4 )$$

η=ϕ₀²/r and W(t) is a noise term that represents a Wiener process or Brownian motion. ∇U represents the gradient or derivative of the potential U(φ), and the dot and double dot notations represent a single and double derivative with respect to time.

Equation 4 can be reorganized as shown in the following equation:

$$\ddot{φ} = - \frac{{I}_{c} ( {\tilde{φ}}_{D C} )}{{ϕ}_{0} C} sin ( φ ) - \frac{1}{L C} ( φ - {\tilde{φ}}_{L} ) - \frac{1}{R C} \dot{φ} - \sqrt{\frac{2 γ {k}_{B}}{R {C}^{2} {ϕ}_{0}^{2}}} W ( t ) \qquad ( 5 )$$

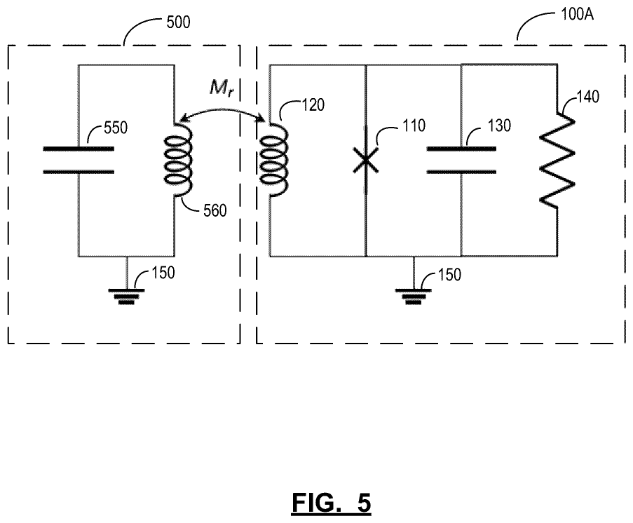

Referring next to FIG. 5, there is shown the circuit of the superconducting thermodynamic neuron 100A of FIG. 1, coupled to an example readout circuit 500. A readout circuit can allow information about the superconducting thermodynamic neuron 100A to be extracted. As shown, the readout circuit 500 can be a resonator circuit, which includes a capacitor 550 in parallel with an inductor 560 and coupled to ground 250. The readout circuit 500 can be coupled (e.g., inductively, capacitively, galvanically) to external electronics (not shown), which can send to the readout circuit 500 and receive signals from the readout circuit 500. As shown, the readout circuit 500 can be inductively coupled to the circuit of the superconducting thermodynamic neuron 100A. The readout circuit 500 can measure the phase (position, state) q of the superconducting thermodynamic neuron 100A. The measurement can be a discrete measurement or a continuous measurement.

Though the readout circuit 500 is shown, other types of readout circuits can be coupled to the circuit of superconducting thermodynamic neuron 100A and other modes of coupling can be used. The readout circuit can be any type of circuit that enables information about the superconducting thermodynamic neuron 100A to be measured and can couple to any part of the circuit from which measurements can be obtained. For example, the readout circuit can be coupled to the capacitive element 230 and can measure the charge of the capacitive element 230. In some embodiments, the readout circuit can include one or more Josephson junctions.

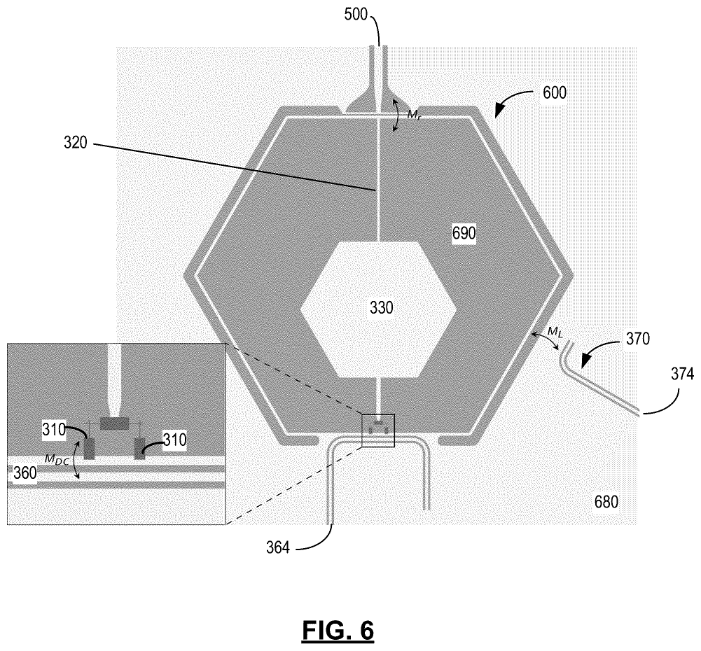

Referring now to FIG. 6, there is shown a schematic diagram of an example superconducting thermodynamic neuron 600 coupled to a DC SQUID control circuit 360, a readout circuit 500 and a main inductance loop control circuit 370. In the embodiment shown in FIG. 6, the superconducting thermodynamic neuron 600 is a lumped element circuit that has a hexagonal capacitive element 330 (i.e., a capacitive island), a gradiometric inductive element 320 that encircles the capacitive element 330 and Josephson junctions 310 arranged in a DC SQUID loop below the capacitive element 330.

The superconducting thermodynamic neuron 600 is inductively coupled to a readout circuit 500, inductively coupled to DC SQUID control circuit 360 and inductively coupled to the main inductance loop control circuit 370. A gradiometric configuration can prevent stray magnetic flux in the environment from affecting the magnetic flux of the main inductance loop control circuit 370.

The superconducting thermodynamic neuron 600 can be fabricated with a superconducting ground plane 680 that encircles the superconducting thermodynamic neuron 600 and connects to the DC SQUID control circuit 260 the main inductance loop control circuit 370. The superconducting ground plane 680 and the superconducting thermodynamic neuron 600 can be made of any suitable superconducting material, including, but not limited to aluminum and niobium. The superconducting thermodynamic neuron 600 and the superconducting ground plane 680 can be part of the same layer of material. The surface 690 can be a substrate made of any material typically used in the fabrication of integrated circuits, including, but not limited to silicon.

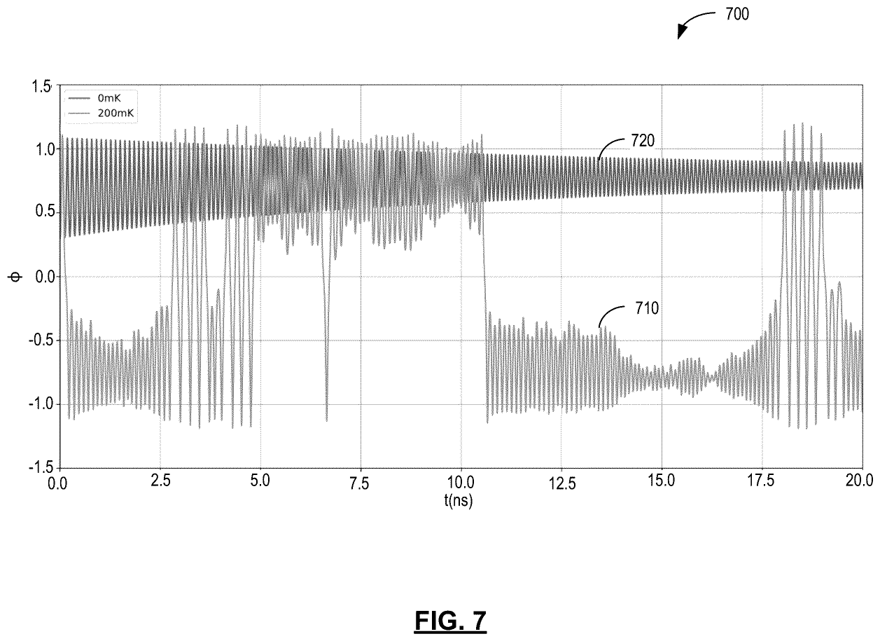

Reference is made to FIG. 7, which shows a graph 700 of the position (i.e., phase) φ as a function of time of a superconducting thermodynamic neuron such as any of the superconducting thermodynamic neurons described with reference to FIGS. 1A-6 having a potential defined by a double well. As explained, the phase of the superconducting neuron varies in time, due to thermal noise and external control signals (i.e., signals from the DC SQUID control circuit 360 and signals from the main inductive loop control circuit 370 varying the magnetic fluxes applied). The superconducting neuron can therefore trace out a trajectory in time and φ-space as shown in FIG. 7. In the example of graph 700, the external control signals are fixed and accordingly changes in the phase φ of the superconducting thermodynamic neuron are due to the dynamics of the superconducting thermodynamic neuron, as defined in Equation 4, including thermal noise.

As shown by plot 710, when the superconducting thermodynamic neuron is operating at 200 mK, due to the presence of thermal noise, the position φ of the superconducting thermodynamic neuron oscillates switching from one well to another. In contrast, as shown by plot 720, when the superconducting neuron is operating at 0 mK, there is no thermal noise, and therefore the position of the superconducting thermodynamic neuron oscillates without any noise.

As explained, two or more superconducting thermodynamic neurons can be coupled to form a network of superconducting thermodynamic neurons.

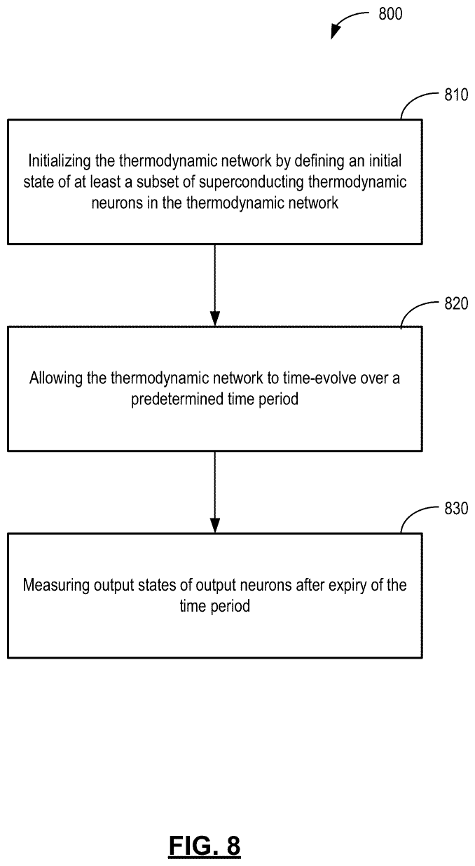

Referring next to FIG. 8, there is shown a flowchart of an example method 800 of operating a thermodynamic network that includes a plurality of superconducting thermodynamic neurons. The thermodynamic network can be operated at cryogenic temperatures. The thermodynamic network can include at least input neurons that can be configured with input data and output neurons from which output data can be read. In at least some embodiments, some superconducting thermodynamic neurons in the thermodynamic network may not be input neurons nor output neurons. That is, the plurality of superconducting thermodynamic neurons in the thermodynamic network can include input neurons, output neurons and one or more intermediate neurons. The output neurons can be the same as the input neurons or can be different from the input neurons, depending on the implementation of the thermodynamic network.

At 810, the method 800 involves initializing the thermodynamic network by defining an initial state of at least a subset of the superconducting thermodynamic neurons in the thermodynamic network. Initializing the thermodynamic network can involve defining an initial state of each input neuron in the thermodynamic network. In some embodiments, step 810 involves defining the initial state of each superconducting thermodynamic neuron in the thermodynamic network.

The initial state of an input superconducting thermodynamic neuron can be defined based on an encoding of input data that is being input into the thermodynamic network. For example, input data can be encoded into the thermodynamic network by setting the initial phase φ of superconducting thermodynamic neurons. The encoding scheme can vary, depending on the problem solved and/or the size of the thermodynamic network. For example, a binary encoding scheme, where the left well is assigned the binary variable 1 and the right well is assigned the binary variable 0 can be used although it will be apparent that various alternative encoding schemes could also be used. The initial phase φ of a superconducting thermodynamic neuron can be set by using the external controls.

For example, during initialization, the position of a superconducting thermodynamic neuron can be constrained to a selected well (e.g., left well, right well) depending on the value to be encoded, by applying a first pulse to lower the barrier between the two wells, applying a second pulse to tilt the potential of the superconducting thermodynamic neuron toward the selected well and a third pulse to raise the barrier between the two wells.

The initial state of non-input superconducting thermodynamic neurons can also be defined at 810. Defining the initial state of a non-input superconducting thermodynamic neuron can involve initializing the superconducting thermodynamic neuron to a predetermined state, for example, in a similar manner to defining the initial state of an input superconducting thermodynamic neuron, or to a random state.

During initialization, the externally controllable parameters and inputs, including the external neuron controls (i.e., the DC SQUID control circuit 360 and the main inductive loop control circuit 370) can also be initialized.

In at least some embodiments, initializing the thermodynamic network involves setting the coupling strengths between the superconducting thermodynamic neurons, for example, the coupling strengths of tunable couplers coupling the superconducting thermodynamic neurons, to predetermined coupling settings. The coupling settings coupling can be determined based on desired parameters for the circuit of superconducting thermodynamic neurons, for example, the coupling settings can be determined by operating the thermodynamic network through an iterative learning process.

The learning process can be a process that is defined to optimize the energy function of the thermodynamic network. As described previously, the energy function of the thermodynamic network can be defined based on a model of dynamics of the thermodynamic network.

The learning process can involve encoding input training data into a thermodynamic network, measuring an output state of the thermodynamic network after time-evolving the thermodynamic network and using an optimization process (e.g. stochastic gradient-based optimization) to determine the desired parameters. The optimization process can be repeated over a series of iterations in order to learn the desired parameters.

For example, the process can be repeated a number of times (e.g., 100<N<10,000,000) and the measured output states can be averaged. Based on the comparison between the average measured output state and an expected output state, the strength of the tunable couplers can be adjusted. The process can be repeated until the energy function of the thermodynamic network is optimized or until a preset number of training epochs have been completed. The strength of the tunable couplers when the energy function if optimized can be used during operation of the thermodynamic network as the predetermined coupling settings.

In some embodiments, initializing the thermodynamic network involves defining neuron parameters. For example, defining the neuron parameters can involve adjusting the height of the barrier between the two wells and/or the tilt of each superconducting thermodynamic neuron to predetermined values. The predetermined values can be determined using a training process, for example, a learning process that is defined to optimize the energy function of the thermodynamic network.

At 820, the method 800 involves allowing the thermodynamic network to time-evolve over a relaxation time period. The relaxation time period can correspond to the time period necessary for the thermodynamic network to reach equilibrium or can be a pre-determined, fixed time period. The length of the pre-determined time period can vary, depending on the application for which the thermodynamic network is used. During the time-evolution, the phase of the neurons can change due to noise.

The external controls and the coupling strengths can be set to their final readout values to stop the time-evolution. The final readout values can be predetermined. For example, the final readout coupling strengths can be set to 0.

In some embodiments, at least some of the neuron parameters and/or the coupling strengths are dynamically varied during the time-evolution. For example, in some applications of the thermodynamic network, it may be advantageous to vary the coupling strengths and/or the neuron parameters to pause the time-evolution of a portion of the thermodynamic network and/or to change the behavior of the thermodynamic network.

At 830, after expiry of the time period, the method 800 involves measuring output states of output neurons. The output states of the output neurons can be measured using readout circuits, described with reference to FIG. 5.

In some embodiments, the method 800 involves decoding the output states measured at 830 to obtain output data that is associated with the initial state of the thermodynamic network. Decoding the output states can involve determining the final phase φ of each output superconducting thermodynamic neuron and decoding the determined final phases φ according to the encoding scheme used to encode the input data into the thermodynamic network.

As explained, the superconducting thermodynamic neurons described herein can be particularly well-suited for machine-learning applications, for example, machine-learning applications involving energy-based models (EBM).

For an EBM with a potential energy function ε_{θ}(x), the probability of finding the system in a state x given model parameters θ is defined by the following equation:

$${p}_{θ} ( x ) = \frac{{e}^{- {ε}_{θ} ( x )}}{Z} \qquad ( 6 )$$

where Z is the partition function that normalizes the probability distribution.

A particular EBM can be trained by setting the parameters θ such that the states x of the system that are correct correspond to a lower total energy than incorrect states. The probability of occurrence of the correct states is accordingly higher.

A network of superconducting thermodynamic neurons described herein can have a potential energy ε_{θ}(x), where the state x corresponds to the state φ (i.e., phase, position) of all neurons and the parameters θ correspond to the coupling strengths between the neurons.

For particular coupling strengths between the superconducting thermodynamic neurons, measuring the state of each neuron after having reached thermal equilibrium is equivalent to sampling the probability distribution p_{θ}.

As explained, the EBM can be trained using training data, which can be used to update the parameters θ. The training data can correspond to a collection of known states xₜ that the EBM should encode with a low energy. The parameters θ can be updated in various ways, for example using a stochastic gradient optimization algorithm, as that described by Welling and Teh in “Bayesian Learning via Stochastic Gradient Langevin Dynamics”. In: Proceedings of the 28th International Conference on International Conference on Machine Learning. ICML′11. Bellevue, Washington, USA: Omnipress, 2011, pp. 681-688. isbn: 9781450306195 and described by the equation below:

$${θ}_{t + 1} = {θ}_{t} - \frac{{ϵ}_{t}}{2} N ( \frac{1}{n} {\sum }_{i = 1}^{n} {∇}_{{θ}_{t}} {ε}_{{θ}_{t}} ( {x}_{{t}_{i}} ) - {E}_{X ∼ {p}_{{θ}_{t} ( x )}} [ {∇}_{{θ}_{t}} {ε}_{{θ}_{t}} ( x ) ] ) + {η}_{t} \qquad ( 7 )$$

The expectation value in equation 7 above can be obtained from the physical circuit by measuring the state of the neurons many times to obtain the distribution. The gradients with respect to θ can be calculated by an external system, for example, an external computer. Alternatively, the neuron couplings can be encoded as degrees of freedoms in the circuit of superconducting thermodynamic neurons (i.e., as neurons). In such cases, computing the gradient can be achieved by measuring the state of this expanded circuit as a function of time. The EBM can be progressively trained by evaluating Equation 7 and changing the physical circuit parameters accordingly.

While the present application has been described with reference to examples, it is to be understood that the scope of the claims should not be limited by the embodiments set forth in the examples, but should be given the broadest interpretation consistent with the description as a whole.

We claim:

1. A method of operating a thermodynamic network comprising a plurality of superconducting neurons and a plurality of tunable couplers, wherein each superconducting neuron of at least a subset of the plurality of superconducting thermodynamic neurons is coupled to at least one other superconducting thermodynamic neuron via a corresponding tunable coupler, the method comprising:
initializing the thermodynamic network by defining an initial state of at least a subset of the plurality of superconducting thermodynamic neurons corresponding to input neurons in the thermodynamic network;
allowing the thermodynamic network to time-evolve over a predetermined time period; and
measuring a plurality of output states of a corresponding plurality of output neurons of the plurality of superconducting thermodynamic neurons after expiry of the time period.

2. The method of claim 1, wherein the initial state of the at least subset of the plurality of superconducting thermodynamic neuron is defined based on an encoding of input data being input into the thermodynamic network.

3. The method of claim 1, wherein initializing the thermodynamic network comprises setting coupling strengths of the tunable couplers to predetermined coupling settings.

4. The method of claim 3, wherein the predetermined coupling settings are determined by operating the thermodynamic network through an iterative learning process, wherein the learning process is defined to optimize an energy function of the thermodynamic network.

5. The method of claim 4, wherein the energy function of the thermodynamic network is defined based on a model of dynamics of the thermodynamic network.

6. The method of claim 1, wherein initializing the thermodynamic network comprises defining neuron settings of at least a subset of the input neurons, the neuron settings comprising one or more of: a barrier height and a tilt of the superconducting neuron.

7. The method of claim 6, further comprising dynamically adjusting one or more of:
at least some coupling strengths of the tunable couplers and at least some of the neuron settings during the predetermined time period.

8. The method of claim 1, further comprising decoding the plurality of output states to obtain output data associated with the initial state of the thermodynamic network.

9. The method of claim 1, wherein the superconducting thermodynamic neurons comprises a second subset of superconducting neurons coupled pairwise through mutual inductance.

10. The method of claim 1, wherein each of the plurality of superconducting thermodynamic neurons comprises:
one or more Josephson junctions;
an inductive element;
a capacitive element; and
a resistive element,
wherein the one or more Josephson junctions, the inductive element, the capacitive element and the resistive element are connected in parallel.

11. A superconducting thermodynamic system comprising:
a thermodynamic network comprising:
a plurality of superconducting thermodynamic neurons,
a plurality of tunable couplers, wherein each superconducting neuron of at least a subset of the plurality of superconducting neurons is coupled to at least one other superconducting neuron via a tunable coupler of the plurality of tunable couplers;
a readout circuit coupled to a plurality of output neurons of the plurality of superconducting neurons for measuring output states of the output neurons; and
a controller for tuning coupling strengths of the tunable couplers.

12. The system of claim 11 wherein at least a subset of the plurality of superconducting thermodynamic neurons correspond to input neurons and wherein an initial state each input neuron is defined based on an encoding of input data being input into the thermodynamic network.

13. The system of claim 11, wherein the controller is configured to tune the coupling strengths to predetermined coupling settings.

14. The system of claim 13, wherein the predetermined coupling settings are determined by operating the thermodynamic network through an iterative learning process, wherein the learning process is defined to optimize an energy function of the thermodynamic network.

15. The system of claim 14, wherein the energy function of the thermodynamic network is defined based on a model of dynamics of the thermodynamic network.

16. The system of claim 11, wherein the controller is configured to define neuron settings of at least a subset of the input neurons, the neuron settings comprising one or more of: a barrier height and a tilt of the superconducting neuron.

17. The system of claim 16, wherein the controller is configured to dynamically adjust one or more of: at least some coupling strengths of the tunable couplers and at least some of the neuron settings when the thermodynamic network is time-evolved.

18. The system of claim 11, wherein the plurality of output states are decodable to obtain output data associated with an initial state of the thermodynamic network.

19. The system of claim 11, wherein the superconducting thermodynamic neurons comprises a second subset of superconducting neurons coupled pairwise through mutual inductance.

20. The system of claim 11, wherein each of the plurality of superconducting neurons comprises:
one or more Josephson junctions;
an inductive element;
a capacitive element; and
a resistive element,
wherein the one or more Josephson junctions, the inductive element, the capacitive element and the resistive element are connected in parallel.
